(19) United States
(12) Patent Application Publication
(10) Pub. No.: US 2005/0229866 A1
(43) Pub. Date: Oct. 20, 2005

(54) Collapsible pet housing

(76) Inventors: Jeffrey M. Simpson, Auburn, AL (US); Mark A. Haley, Asheville, NC (US)

Correspondence Address: GARDNER GROFF, P.C., 2018 POWERS FERRY ROAD, SUITE 800, ATLANTA, GA, 30339, US

(21) Appl. No.: 11/105,313

(22) Filed: Apr. 13, 2005

Related U.S. Application Data
(63) Continuation-in-part of application No. 29/203,474, filed on Apr. 14, 2004.
(60) Provisional application No. 60/562,117, filed on Apr. 14, 2004.

(51) Int. Cl. A01K 1/03

(52) U.S. Cl. 119/499

(57) ABSTRACT

A collapsible pet housing is quickly and easily assembled with minimal or no tools. The pet housing has a hinged frame formed of a substantially rigid material and a plurality of fabric panels secured to the frame. The pet housing also includes tie-down eyelets and pivoting-hinge knee and corner joints for collapsing the pet housing into a compact configuration.

### CROSS-REFERENCE TO RELATED APPLICATION

This application claims priority to U.S. Provisional Patent Application Ser. No. 60/562,117 filed Apr. 14, 2004 and U.S. Design Pat. Application 29/203,474 filed Apr. 14, 2004. U.S. Provisional Patent Application Ser. No. 60/562,117 and U.S. Design Pat. Application 29/203,474 are hereby incorporated herein by reference in their entireties for all purposes.

### TECHNICAL FIELD

The present invention relates generally to the field of pet products, and more particularly to collapsible housings for domestic pets. The invention also relates to collapsible pet housings that can be shipped and/or stored in a folded or disassembled state and which can be easily set up or assembled for use, and subsequently re-folded or disassembled for storage and/or transport.

### BACKGROUND OF THE INVENTION

Millions of people in the United States and throughout the world have domesticated pets. When traveling, many of these people prefer to travel with their pets rather their leaving their precious pets in an unfamiliar environment such as a boarding kennel.

Conventional pet carriers or crates typically are formed of injection molded plastic, wire, or fabric. Currently, plastic injection molded carriers dominate the carrier market for several reasons. Such carriers are approved by many of the airlines and have greater structural integrity than the wire form. Plastic carriers provide better environmental protection than the wire form carriers, but the plastic carriers have vents on each side of the top half of the unit as well as a wire form door, which allows moisture (snow, sleet, rain, etc.) to enter the carrier if not covered with a separate cover.

Some plastic carriers have two injection molded halves which are joined together about a belt line with various fasteners. When the device is not in use, the top half can be detached and inverted, so that it can be stored within the bottom half, or vice versa, which reduces the volume requirement for stowability to about 60% of the erected form. Other plastic carriers have been developed to be disassembled in a manner much like that of a typical wire kennel. However, these plastic carriers lack the environmental protection afforded by the traditional plastic injection molded carriers.

Wire form carriers (generally referred to as wire crates) can be used as carriers, but the wire crates do not provide comparable structural or environmental protection that is afforded to plastic carriers. Thus, wire crates are generally used for containing a pet in a home or other area rather than for transporting a pet. Wire crates also must be enclosed with a separate cover to protect the pet from inclement weather.

Similarly, tent crates, or those made of a fabric (nylon or polyester) woven over an aluminum or fiberglass structure, serve primarily as temporary containment devices in the home or at a temporary location such as a hotel/motel or alternate residence. Tent crates generally erect and collapse easily, and in the collapsed form, tent crates are easily carried and stowed. The structural integrality of a tent crate typically is even less than that of the wire form crate.

Users of carriers prefer that the carriers be safe for their pets and simple to use. Users also prefer that the carriers be simple to assemble and disassemble and store in a compact form when not in use. Thus, it can be seen that current carriers have several disadvantages. First, many conventional plastic carriers do not collapse or break down easily into compact pieces. Thus, such carriers require significant storage space when not in use or when being transported empty.

A second drawback to conventional carriers is that they do not allow the owner to easily secure the carrier in place, such as in a vehicle. Often, the user must set the carrier on the seat or floor of the vehicle. However, such placement, when not secured, permits the carrier to slide along the seat or floor, which increases the risk of injury to the pet and to nearby occupants of the vehicle.

Thus it can be seen that needs exist for improvements to pet housings to provide a housing that is safe for the pet, collapsible, portable, and securable in a vehicle.

### SUMMARY OF THE INVENTION

The present invention is a collapsible housing for pets. In example embodiments, the housing of the present invention is safe, portable and collapsible or foldable for compact storage and shipping, and is easily assembled by one person without tools or with only minimal tools. In further embodiments, the housing of the present invention provides environmental protection for the pet from inclement weather, including precipitation and high winds. In further embodiments, the housing of the present invention is fabricated from materials that do not absorb moisture or odors, that resist damage and deterioration from moisture, mold, mildew and the like, and which is easily cleaned. In further embodiments, the housing of the present invention is securable in a vehicle.

In one aspect, the present invention is a collapsible pet housing comprising a hinged frame formed of a substantially rigid material and a plurality of fabric panels secured to the frame. The frame includes a plurality of rail members pivotally connected to a plurality of post members. Preferably, the frame comprises extruded aluminum tubes, and the extruded aluminum tubes further comprise at least one slit for receiving an edge of a fabric panel. Also preferably, the pet housing comprises corner brackets for connecting post and rail members of the frame and wherein each corner bracket has two sockets for receiving ends of rails and a flanged hinge arm with a socket for receiving an end of a post.

In another aspect, the invention is a pet housing comprising a plurality of fabric panels, wherein the plurality of panels forms a box-like structure in an open configuration. Preferably, one of the panels defines a flap opening therein for use as a window or a door.

In still another aspect, the invention is a frame for a pet housing including upright posts with rails extending therebetween. Each post has an upper post segment and a lower post segment, wherein the upper and lower post segments of each post are pivotally connected by a knee joint at inner ends thereof. The outer ends of the upper and lower post segments of each post are pivotally connected to at least one rail by a corner bracket. Preferably, each knee joint comprises a lockable hinge joint. Also preferably, each knee joint limits pivotal motion of the upper and lower post segments to a range of about 0° to about 180° relative to one another as well as resists out-of-plane motion of the upper and lower post segments. In one aspect, each hinge joint comprises a cogged locking nut. In another aspect, each hinge joint comprises a pair of sleeves having holes for receiving a locking pin. In yet another aspect, each hinge joint further comprises a rotatable locking bracket that engages a cooperating lock-nut. Also preferably, the housing is collapsible into a compact configuration, wherein the housing is substantially flat in the compact configuration.

In yet another aspect, the invention is a pet enclosure including a frame and a plurality of fabric panels secured to the frame. The frame has upright posts with rails extending therebetween, wherein each post has an upper post segment and a lower post segment. The upper and lower post segments of each post are pivotally connected by a knee joint at inner ends thereof, and the outer ends of the upper and lower post segments of each post are pivotally connected to at least one rail by a corner bracket. Preferably, the upright posts and the rails comprise extruded aluminum tubes, wherein each tube has at least one slit for receiving an edge of a fabric panel.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is an upper perspective view of a pet housing according to an example embodiment of the present invention.

FIG. 2 is a lower perspective view of the pet housing of FIG. 1, shown partially collapsed and showing window and door flaps closed.

FIG. 3 is a lower perspective view of the pet housing of FIG. 1 shown fully collapsed.

FIG. 4 is a cross sectional view of a tubular rail component of a pet housing according to an example embodiment.

FIG. 5 is a perspective view of a corner bracket of the pet housing of FIG. 1 according to an example embodiment.

FIG. 6 is a perspective view of a knee joint of the pet housing of FIG. 1 according to an example embodiment.

FIG. 7A is a partial exploded view of the knee joint of FIG. 6.

FIG. 7B is a side view of a flange portion of the knee joint of FIG. 7A.

FIGS. 8A and 8B are perspective views of a knee joint for a pet housing according to another example embodiment, shown in extended and folded configurations.

FIGS. 9A through 9D show a knee joint for a pet housing according to another example embodiment.

FIGS. 10A and 10B are perspective views of a knee joint for a pet housing according to another example embodiment.

FIG. 11 is a perspective view of a carrier for the pet housing according to an example embodiment of the invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

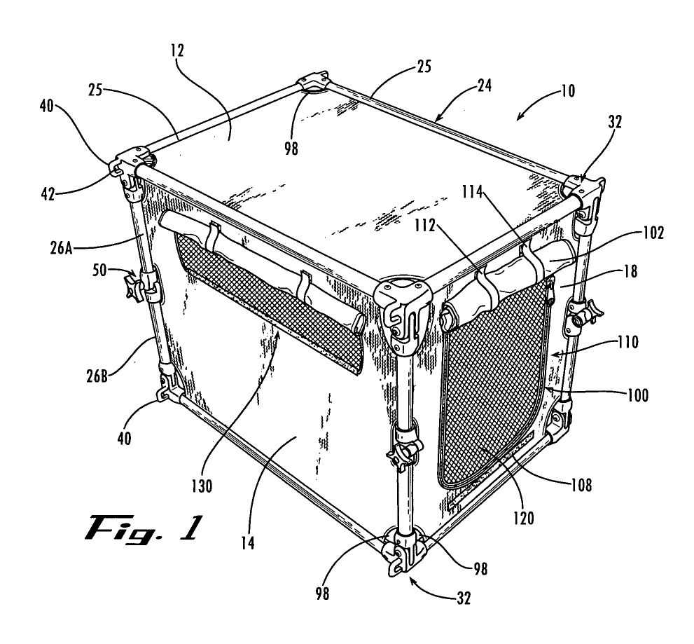

With reference now to the drawing figures, a pet housing 10 is shown by way of example embodiments of the present invention. In its assembled and upright configuration, the pet housing 10 preferably comprises a plurality of generally rectangular panels, preferably including a top panel 12; first and second side panels 14, 16; a front panel 18; a back panel 20; and a bottom panel 22, as shown in FIGS. 1-3, secured to a rigid, load-bearing frame 24. When the housing is in this assembled or set-up configuration as shown in FIG. 1, the side panels 14, 16 and the end panels 18, 20 are upright and generally perpendicular to the generally horizontal bottom panel 22; the side panels 14, 16 are generally parallel to one another and generally perpendicular to the end panels 18, 20; and the top panel 12 is generally perpendicular to the side panels 14, 16 and the end panels 18, 20; thereby forming a generally rectangular box-like structure with an interior chamber for housing a pet.

The top, end, and side panels are preferably constructed of a durable flexible fabric such as ballistic nylon or canvas. The bottom panel 22 preferably is constructed of a more durable material, such as a metal or hard plastic. Preferably, the bottom panel 22 resembles a tray and is permanently secured to the frame 24. In alternate embodiments, the floor panel can be removably secured to the frame 24. The bottom panel 22 can also include a plurality of cross-slats 23 or supports for added stability. In an open configuration, the panels preferably have a tight fabric finish.

The frame 24 preferably comprises a plurality of tubular end and side rails 25 and posts 26, each preferably comprising anodized extruded aluminum, plastic or other structural material. A plurality of pairs of generally upright corner posts 26 engage ends of the side panels and the end panels. A plurality of lateral rails 25 connects the end and side panels to the upper and lower panels. Preferably, the rails 25 and posts 26 have cross sections as depicted in FIG. 4, with two channels or slits 28, 30 extending along their length, one slit for receiving and securing the edge of a first panel and a second slit for receiving and securing the edge of an adjacent panel that is perpendicular to the first panel. Preferably, the slits 28, 30 receive hems that are sewn at the edges of the panels. Additionally, a rod 31 can be placed within each hem of each panel, for better securing the panels within the rails 25 and posts 26.

At each corner of the generally rectangular box-like structure is a corner bracket 32. Each corner bracket 32 has a fixed portion 33 and a pivotal portion 34 hingedly connected to the fixed portion. The fixed portion 33 joins two orthogonal rails 25 to the pivotal portion 34, which in turn attaches to a perpendicular upright post 26. Preferably, the corner brackets are permanently affixed to the posts and rails. As depicted in FIG. 1, a plurality of rivets can be used to secure the brackets 32 to the posts and rails, or alternatively, the corner brackets can be secured to the posts and rails with other fasteners, such as screws, bolts, adhesives, welding, snap-fittings or the like.

The distal end of each post 26 attaches to the pivotal portion 34 of the corner bracket 32. The pivotal portion 34 allows the pet housing 10 to be collapsed by allowing the upright posts 26 to fold inwardly. The pivotal portion 34 has an end with a flange or blade 35 that rotatably engages within an interior pocket 36 of the fixed portion 33. As seen more clearly in FIG. 5, the blade 35 has a curved radius that abuts against a cooperating surface in the pocket 36 of the fixed portion 33 of the corner bracket 32, and thereby works as a mechanical stop to limit the range of rotation of the pivotal portion 33 about its hinged connection, from about 0° to about 90°. Engagement of the blade 35 within the pocket 36 of the corner bracket assembly 32 also braces the hinged joint against lateral movement or twisting to provide a more rigid frame that can withstand loads, including for example, a wind load on the structure when the housing is secured in the bed of pickup truck traveling at highway speeds.

Preferably, a generally U-shaped bracket or eyelet 40 protrudes from each of the corner brackets 32, and defines an opening 42 therethrough. A bungee cord, rope, or the like can be inserted through the opening 42 in the eyelet 40 and tied to an external structure such that the pet housing can be secured in place, including for example, on the seat of a vehicle or in the bed of a truck. All eight corner brackets 32 preferably have an eyelet 40 for receiving a cord, rope, or the like, and the ends of the cord, rope, or the like can then be tied or secured to a fixed point or points in the vehicle, which ultimately secures the pet housing 10 in a single location.

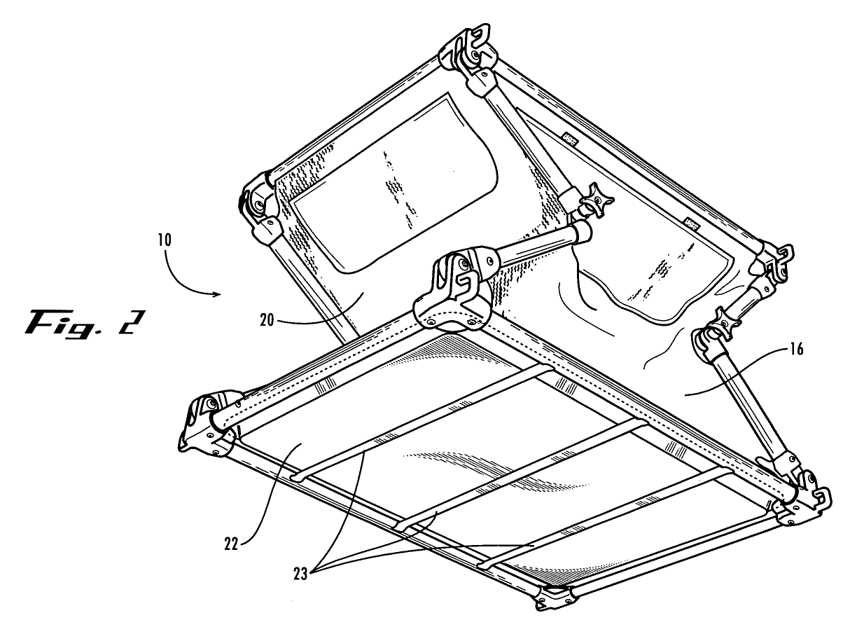

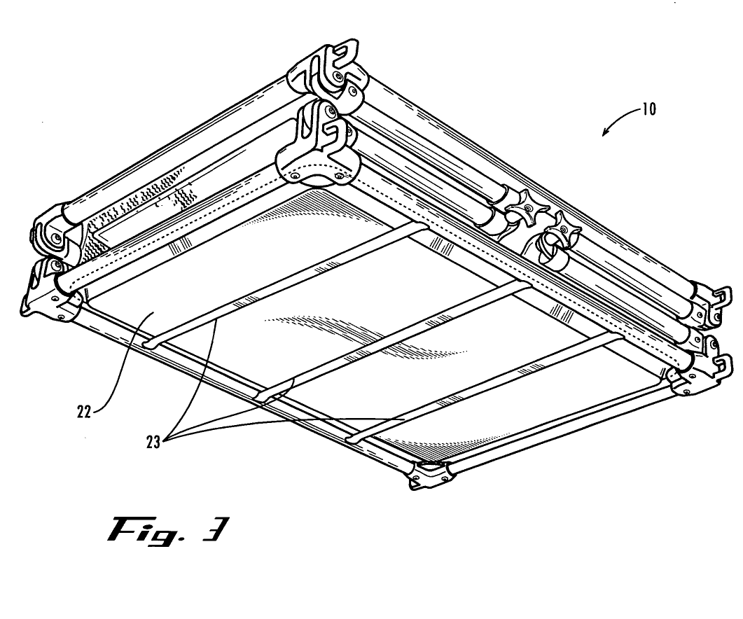

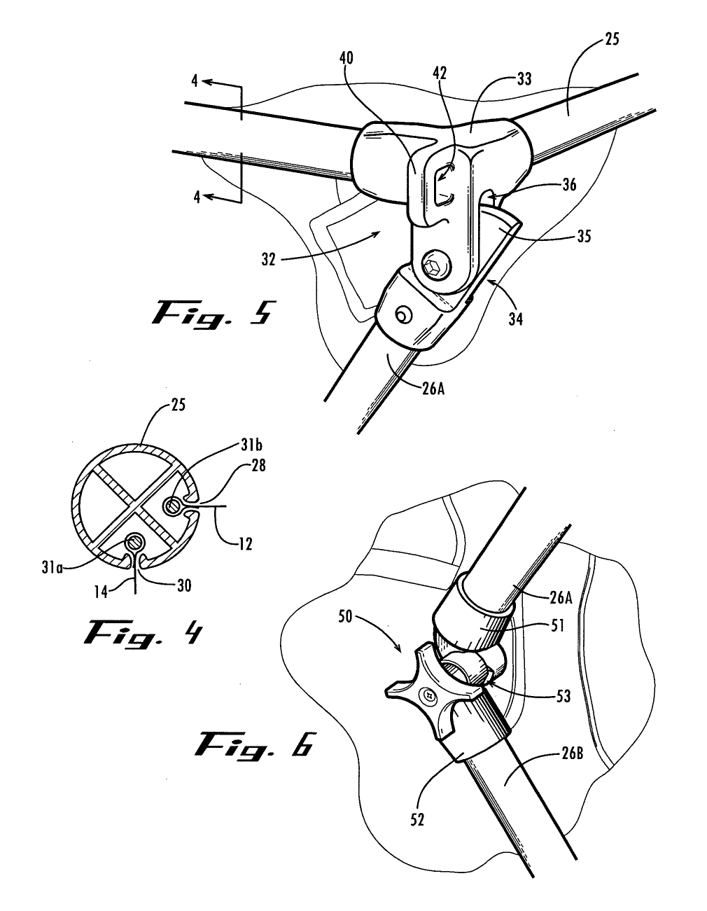

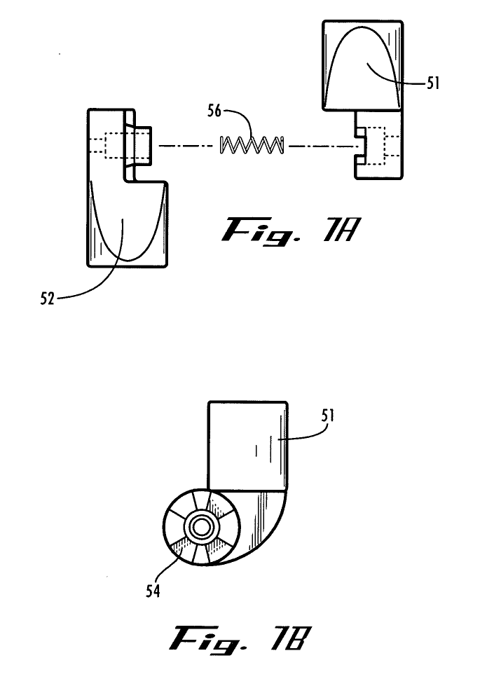

Each upright post 26 of the frame 24 preferably comprises an upper post section 26A and a lower post section 26B, and the sections are preferably connected together with a knee joint 50. Preferably, the upper and lower post sections 26 are of approximately equal length. With particular reference to FIGS. 6, 7A and 7B, a first example embodiment of the knee joint 50 has two sockets formed by tubular flanges 51, 52, each for receiving an end of a post section 26A or 26B. The flanges are connected together by a lockable hinge 53. Preferably, the ends of the post sections 26 are permanently secured within the sockets 51, 52, as by rivets, adhesive, welding or other attachments. The flanges 51, 52 preferably have interengaging cogs 54 on their confronting faces, which receive and lock with each other when the joint 50 is fully opened and when the joint 50 is fully closed, as more clearly seen in FIGS. 7A and 7B. The two flanges can rotate about the hinged connection therebetween from a position of about 0° (when the hinge is fully closed) to about 180° (when the hinge is fully opened). Moreover, the joint 50 can open, or fold, in a single direction only, within the plane of the side panel, which aids in the stability and integrity of the pet housing 10. Positioned between the confronting faces of the two flanges 51, 52 is a spring 56 for biasing the flanges away from each other for disengagement. The hinge 53 preferably further comprises a rotatable locknut with a knob 58 that can be tightened against the hinge 53, which compresses the spring 56 and allows the cogs to interengage, to prevent rotation, and loosened to permit rotation.

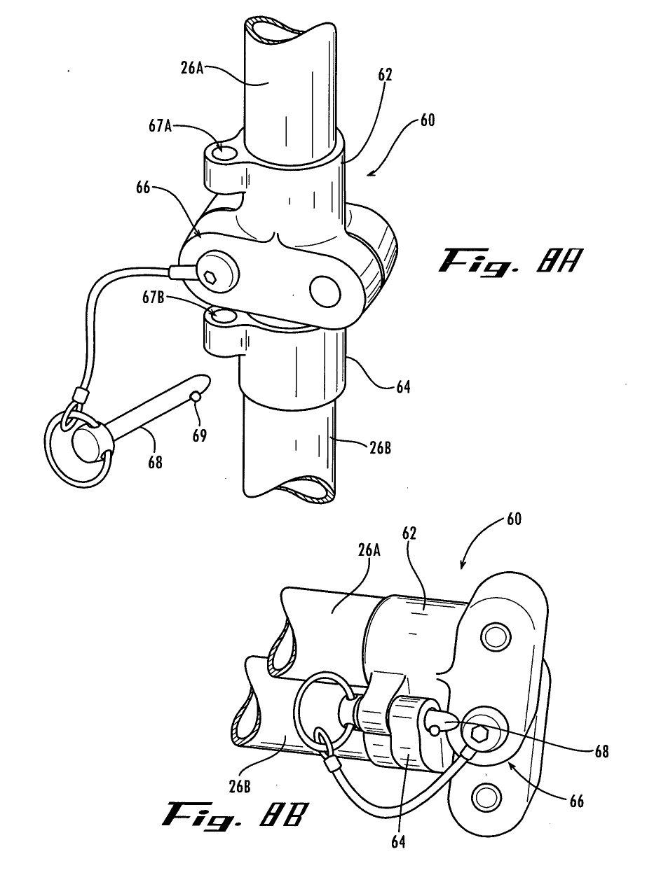

An alternative embodiment of a knee joint 60 is depicted in FIGS. 8A and 8B. The knee joint 60 has two tubular flanges 62, 64 that pivot about a hinge 66. Each flange 62, 64 has a sleeve forming an opening for receiving a removable locking pin or key 68. The openings align laterally to receive the pin 68 when the hinge is fully opened, to lock the knee joint 60 open as shown in FIG. 8A and thus prevent further movement about the hinge. Optionally, the key 68 can have a spring-loaded ball “keeper” 69 located at an end thereof. The “keeper” 69 aids in securing the key 68 within the openings 67 by providing a spring-loaded ball that engages an outer edge of the sleeve (of the opening 67) when the key 68 is fully extended through the openings 67. Thus, the key 68 functions as a mechanical stop to prevent further movement about the hinge 66. Alternately or additionally, the openings 67 align to receive the pin 68 when the joint 60 is fully closed, as shown in FIG. 8B, to prevent the joint 60 from opening. Preferably the key 68 is permanently tethered to one of the flanges, so that the key will not be lost.

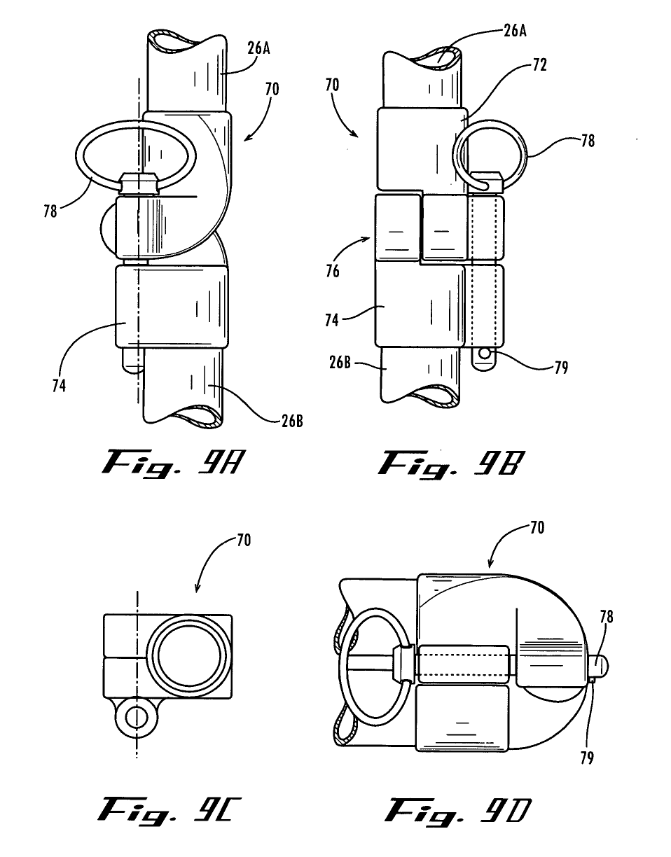

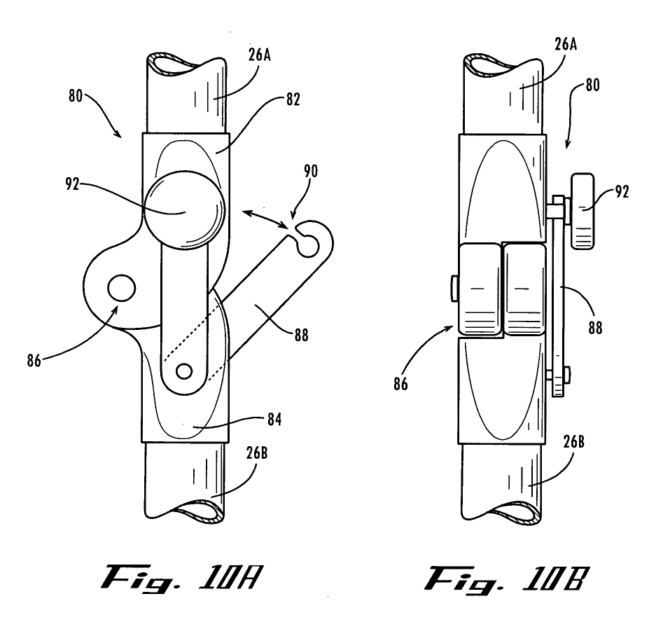

Another alternate embodiment of the knee joint 70 is depicted in FIGS. 9A through 9D. The knee joint 70 is similar to the knee joint 60. The knee joint 70 has two tubular flanges 72, 74 that pivot about a hinge pin 76. Each flange 72, 74 has a sleeve forming an opening for receiving a removable locking pin or key 78. The openings align vertically to receive the key 78 when the hinge is fully opened, to lock the knee joint 70 open and thus prevent further movement about the hinge. The force of gravity will secure the key 78 in place. Optionally, the key 78 can have a spring-loaded ball “keeper” 79 located at an end thereof. The “keeper” 79 aids in securing the key 78 within the openings 76 by providing a spring-loaded ball that engages an outer edge of the sleeve (of the opening 76) when the key 78 is fully extended through the openings 76. Thus, the key 78 functions as a mechanical stop to prevent further movement about the hinge pin 76. Alternately or additionally, the openings 76 align to receive the key 78 when the joint 70 is fully closed, to prevent the joint 70 from opening. Preferably the key 78 is permanently tethered to one of the flanges, so that the key will not be lost.

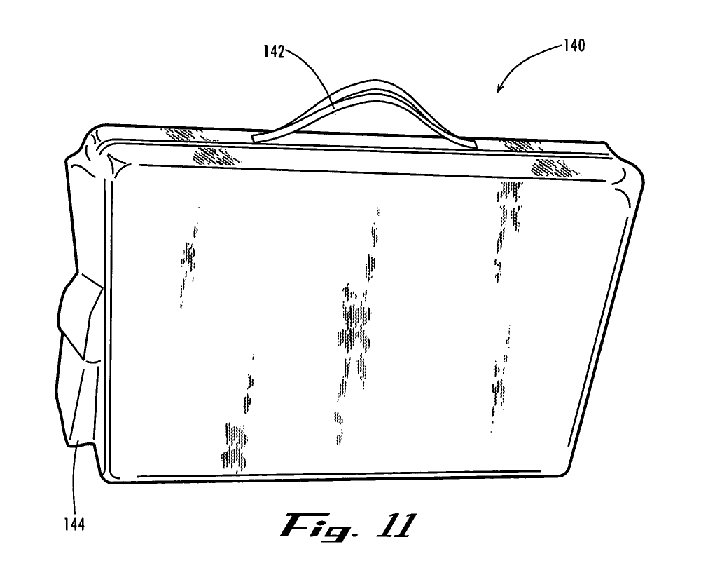

Another alternative embodiment of a knee joint 80 is depicted in FIGS. 10A and 10B. Similar to the above-described embodiments, two tubular flanges 82, 84 receive ends of the pair of upright posts 26, and pivot relative to one another about a hinge 86. A rotatable locking clip 88 is pivotally mounted to one tubular flange. The locking clip 88 preferably has a groove or a notch 90 for engaging the shaft of a cooperating lock-nut 92, which is attached to the other tubular flange. The notch 90 can engage the cooperating element 92 when the knee joint 80 is fully extended and/or when the knee joint 80 is fully collapsed, and the nut 92 tightened such that the knee joint 80 can be locked in either the open or closed positions.

The pivotal hinge points of the knee joints are preferably laterally offset from the post 26, to permit the upper and lower post segments 26A, 26B to be folded flat against one another (i.e., approximately parallel and oriented at a 0° angle relative to one another) when the carrier 10 is fully collapsed. In this manner, the collapsed volume of the carrier 10 is minimized, permitting more compact and inexpensive transport and storage.

The knee joints of the present invention and the corner brackets 32 preferably act in combination to provide strong structural integrity to the pet housing in its expanded upright configuration during use, while also allowing the pet housing to be easily collapsed, preferably without tools, into a very compact configuration for transport and storage. The knee joints of the present invention preferably fold in a single direction only, resisting out of plane motion and preventing pivotal motion of the post segments beyond their fully expanded position at about 180° or slightly past center. And the knee joints of the present invention preferably can be securely locked in their fully open and/or fully closed position(s). The hinge joint formed by the pivotal portion of the corner bracket further resists twisting and out of plane motion, and the flange 35 is solidly engaged within the cooperating pocket 36 of the fixed portion 33 of the corner bracket, resulting in a rigid structural housing frame capable of withstanding considerable downward and/or sideways loads in its upright and expanded configuration. Preferably there are no loose parts or tools that might otherwise be misplaced during transit or storage. Preferably, there are voids 98 in the fabric panels at the locations of the knee joints 50 and the corner brackets 32. The voids 98 allow clearance between the panels and the corner brackets 32 and knee joints 50 such that the pet housing 10 can be more easily collapsed and opened.

The front panel 18 preferably has an opening 100 therein for use as a door for pet ingress and egress to/from the interior of the housing, as more clearly seen in FIG. 1. The opening 100 is preferably covered by an outer flap 102. As depicted in the figures, the outer flap 102 preferably has a first element (not shown) of a hook and loop fastener, such as Velcro®, secured to its inner surface near an edge of the flap. The front panel 18 has an interengaging second element 108 of the hook and loop fastener secured to its front surface 110 such that the second element 108 and the first element of the hook and loop fastener engage each other to close the flap. The front panel 18 preferably also has two straps 112, 114 secured to the front surface 110 above the opening 100. One end of each strap 112, 114 preferably has a first element of a hook and loop fastener and the other end of each strap or the face of the panel has an interengaging portion of the hook and loop fastener. Thus, the outer flap 102 open can be “rolled-up,” and the straps 112, 114 can wrap around the rolled-up flap 102 such that the two ends of the straps engage and secure the flap 102 above the opening 100 of the front panel 18. It should be understood that other types of fasteners, including, for example, snaps, zippers, and buttons, can be employed as well. It should also be understood that the relative position of the fasteners can be moved to other positions along the flap 102 and the front surface 110 of the front panel 18.

The front panel 18 preferably also has a second inner flap 120, preferably constructed of a mesh material, secured thereon with a zipper such that when the inner flap 120 is zipped closed, the pet cannot enter or exit the housing 10. Preferably a mesh material is used because it permits ventilation to the housing 10, and allows visibility to and from the interior of the housing.

The side panels 14, 16 each preferably have a window 130 therein. The windows 130 preferably are covered with a mesh material, and optionally include a flap covering 132 connected to the side panels 14, 16 to cover the windows 130. Similar to the flap 102 covering the opening 100 in the front panel, the window flap 132 preferably uses a hook and loop fastener to secure the flap 132 in a closed position and a pair of straps having hook and loop fasteners thereon for securing the window flap 132 rolled-up in an open position. Thus, the covered windows and door provide environmental protection for the pet.

As shown in FIGS. 2 and 3, the pet housing 10 is preferably collapsible. To collapse the housing 10, the user preferably loosens the knee joints 50 by rotating the lock-nut knobs counterclockwise or otherwise disengaging the knee joint locking features. Once all of the knee joints 50 have been loosened, the user then gently pushes the top panel 12 towards the bottom panel 22 (or vice versa) until the housing 10 collapses into a generally flat, rectangular structure. The knee joints 50 may be pushed inwardly to initiate collapsing of the device. When the housing 10 is fully collapsed, the knee joints 50 are all in their fully closed or collapsed position. In an example embodiment, the housing 10 folds to about six inches flat (i.e., the distance between the top panel 12 and the bottom panel 22 in a closed configuration is about six inches). In alternate embodiments, the knee and corner joints can be omitted, and a lightweight non-collapsible pet home or carrier will be provided.

When the housing 10 is collapsed, it can be stored in a carrying case or a carrier 140, as depicted in FIG. 11. The carrying case 140 has an opening that can be closed with a zipper or other fastener(s) and one or more carrying handles 142. The case 140 preferably also has a pocket 144 for carrying ropes or cords, such as bungee cords, for securing the housing 10 to a structure. The pocket 144 can be located on the exterior of the case 140, as depicted, or the pocket 144 can be located on the interior of the case 140. Additionally, the case 140 can have multiple pockets, some of which are located on the interior of the case and some of which are located on the exterior of the case.

While the invention has been described with reference to preferred and example embodiments, it will be understood by those skilled in the art that a variety of modifications, additions and deletions are within the scope of the invention, as defined by the following claims.

1. A collapsible pet housing comprising a hinged frame formed of a substantially rigid material, wherein the hinged frame further includes a plurality of rail members pivotally connected to a plurality of post members; and a plurality of fabric panels secured to said frame.

2. The pet housing of claim 1, wherein the frame comprises extruded aluminum tubes.

3. The pet housing of claim 2, wherein the extruded aluminum tubes further comprise at least one slit for receiving an edge of a fabric panel.

4. The pet housing of claim 1, wherein the plurality of panels form a box-like structure in an open configuration.

5. The pet housing of claim 4, further comprising an eyelet projecting from a corner of the box-like structure for securing the housing to an external structure.

6. The pet housing of claim 1, wherein the pet housing is collapsible into a substantially flat compact configuration.

7. The pet housing of claim 6, wherein the frame comprises a plurality of lockable knee joints for use in collapsing the pet housing.

8. The pet housing of claim 7, wherein each hinge joint comprises a cogged locking nut.

9. The pet housing of claim 7, wherein each hinge joint comprises a pair of sleeves having holes for receiving a locking pin.

10. The pet housing of claim 7, wherein each hinge joint further comprises a rotatable locking bracket that engages a cooperating lock-nut.

11. The pet housing of claim 1, wherein one of the panels defines a flap opening for use as a window or a door.

12. The pet housing of claim 1, further comprising corner brackets for connecting post and rail members of the frame.

13. The pet housing of claim 12, wherein each corner bracket has a fixed portion comprising two sockets for receiving ends of rails, and a pivotal portion with a socket for receiving an end of a post, wherein the fixed portion comprises a pocket for receiving and engaging a cooperating flange extending from the pivotal portion.

14. A frame for a pet housing comprising upright posts with rails extending therebetween, each post comprising an upper post segment and a lower post segment, said upper and lower post segments of each post pivotally connected by a knee joint at inner ends thereof, and outer ends of said upper and lower post segments of each post being pivotally connected to at least one rail by a corner bracket.

15. The frame of claim 14, wherein each knee joint limits pivotal motion of said upper and lower post segments to a range of about 0° to about 180° relative to one another.

16. The frame of claim 14, wherein each knee joint resists out-of-plane motion of said upper and lower post segments.

17. The frame of claim 14, wherein each knee joint comprises a hinge point laterally offset from the upper and lower post segments.

18. The frame of claim 14, wherein each corner bracket comprises a fixed portion connecting proximal ends of two adjoining rails, and a pivotal portion connected to an outer end of a post segment.

19. The frame of claim 18, wherein one of said fixed portion and said pivotal portion of each corner bracket comprises a flange, and the other of said fixed portion and said pivotal portion of each corner bracket comprises a recess for receiving said flange.

20. The frame of claim 19, wherein said recess and said flange interengage to prevent twisting and out-of-plane motion of the post segment, and to prevent pivotal motion of the post segment beyond 90° relative to either of the two adjoining rails.

21. A pet enclosure comprising a frame and a plurality of fabric panels secured to said frame, wherein said frame has upright posts with rails extending therebetween, each post comprising an upper post segment and a lower post segment, said upper and lower post segments of each post pivotally connected by a knee joint at inner ends thereof, and outer ends of said upper and lower post segments of each post being pivotally connected to at least one rail by a corner bracket, wherein said upright posts and said rails comprise extruded aluminum tubes, each tube having at least one slit for receiving an edge of a fabric panel.
